(19) United States
(12) Patent Application Publication
(10) Pub. No.: US 2015/0201641 A1
(43) Pub. Date: Jul. 23, 2015

(54) LONG-LIFE BAKERY PRODUCT AND METHOD FOR THE PRODUCTION THEREOF

(71) Applicant: BAHLSEN GmbH & Co. KG, Hannover (DE)

(72) Inventors: Uwe Bretschneider, Hannover (DE); Thomas Wurst, Sehnde OT Hoever (DE); Stefan Schimmelpfennig-Wiechell, Wennigsen (DE); Oliver Rahn, Seelze-Doeteberg (DE); Arno Purschke, Barsinghausen (DE); Frank Hoffmann, Wennigsen (DE); Werner Rabi, Ronnenberg (DE)

(21) Appl. No.: 14/417,060

(22) PCT Filed: Aug. 2, 2013
(86) PCT No.: PCT/EP2013/002313

§ 371 Date: Jan. 23, 2015

(30) Foreign Application Priority Data
Aug. 3, 2012 (DE) 10 2012 015 455.0

(51) Int. Cl. A23G 1/54

(52) U.S. Cl. CPC A23G 1/54; A23V 2002/00

(57) ABSTRACT

The invention relates to a baked confectionery good comprising an upper planar plate-like baked product, comprising a lower planar plate-like baked product and comprising at least one planar intermediate layer, which is made of a chocolate mass, characterised in that the intermediate layer comprises a hydrophilic food additive which contains at least one monohydric or polyhydric alcohol or at least one sugar alcohol.

The invention relates to a baked confectionery good and to a method for the manufacture thereof, In particular, the invention relates to a sandwich-like baked confectionery good comprising an upper planar plate-like baked product and a lower planar plate-like baked product. A planar intermediate layer, which consists of a chocolate or a comparable fat-containing filling, is arranged between the two baked products, which are preferably in the form of biscuits, crackers or waffles.

Nowadays, biscuit sandwich products are manufactured and sold in a wide range of forms. On the one hand, the conventional type comprising a foamed, fat-containing filling which is rather soft and creamy at normal temperatures are known. This construction is typical of the sandwich products which are currently predominantly sold in central Europe, consisting of predominantly round biscuits (baked confectionery products) and aerated fat-containing fillings, which are characterised by densities of 0.6 to 1 g/cm³. The foam structure is manufactured in an independent method step, in which air or special gases (for example nitrogen) or gas mixtures (nitrogen and carbon dioxide among other things) are introduced and finely dispersely distributed by shearing. The variety of flavours of these aerated fat-containing fillings ranges from cocoa through nut to milk fillings and fruit-flavour fillings.
Other filled baked confectioneries (shortbreads, meringue pastries, sponge cakes etc.) are known from the fields of fine confectionery, patisseries and industrial baked confectionery manufacture. On the one hand, marmalades and jams are used as a filling layer for connecting two baked goods. Further, fat-containing, soft and creamy, aerated fillings, such as ganache, crème pâtissière, chocolate cream, cocoa cream, beaten egg whites etc. are also used here. A third possibility is to apply thin layers of flowable confectionery substances (for example nougat, glazings or chocolates). These confectionery substances solidify during the cooling of the products after application, as a result of the crystallisation of part of the fat container therein. In these products, it is typical for the intermediate layer to be very thin. Typical thicknesses are in the range of 0.5 to 1.5 mm. These intermediate layers are characterised by a low layer thickness and a rather soft consistency, which is generally brought about by the migration of liquid fat components from the baked good into the chocolate or the intermediate layer and thus the softening of the fat system.

An alternative to these products is the product disclosed in specification DE 197 41 718 C1. In this document, two plate-like baked goods are firmly connected to a third plate-like component (for example a specially shaped chocolate body) by a joining mass, which has been introduced between the baked good and the plate-like chocolate body in each case. The product is distinguished in that the side faces of the plate-like filling are substantially flush with the side regions of the baked product parts.

DE 197 41 717 C1 discloses the method of manufacture by connecting three virtually rigid plate-like bodies using joining mass.

The object of the invention is to provide a baked confectionery good and a method for the manufacture thereof which, with a simple construction and simple configuration, are to prevent the drawbacks of the prior art and create an industrially producible product with is visually appealing and gives great enjoyment when consumed.

According to the invention, the object is achieved by the feature combinations of the independent claims; the respective dependent claims specify further advantageous configurations of the invention.

The present invention thus provides a multi-layer sandwich product consisting of two baked goods and a clearly visible layer of chocolate or a comparable filling. The filling mass is clearly visible. For this purpose, the distance between the two baked goods may vary within the range of 2 to 15 mm, and the filling mass fills the intermediate space uniformly and precisely in terms of shape. The side edges of the filling mass end at the side edges of the baked good pieces in so far as possible, or are offset inwards or outwards, parallel to the plane of the side edges of the baked pieces. The central layer of chocolate meets the sensory expectations typical of a chocolate bar of the same thickness.

In the invention, the terms “chocolate”, “chocolate mass” and “filling” are used as an umbrella term for any type of chocolate in the broadest sense as well as for other fat-containing, substantially water-free confectionery substances. such as nougat masses, truffle masses, chocolate filling masses, cocoa cream, milk cream and comparable filling masses. During processing from a liquid preparation, which is generally at a temperature of 40 to 60 chocolates and fat-containing filling masses are cooled to a temperature suitable for further processing (generally between 25 and 33° C.). In the case of polymorphic fat systems, such as in the cocoa butter in the chocolate, a melt having a defined proportion of seed crystals is produced by suitable temperature-control or seeding methods in accordance with the prior art prior to the processing.

The terms hydrophilic food additive or “hydrophilic constituent” are used as umbrella terms for a wide range of substance systems which may be added to chocolates and confectionery goods, which all have high miscibility with water but no miscibility or only limited miscibility with the fats present in chocolate or filling masses, A hydrophilic food additive within the meaning of the invention contains at least one monohydric or polyhydric alcohol or at least one sugar alcohol (in the following, the monohydric or polyhydric alcohols or sugar alcohols are combined under the term “alcohol according to the invention”). The alcohol or alcohols according to the invention may be in the form of a mixture of a plurality of alcohols according to the invention or of a mixture with water, or else in the form of aqueous solutions and/or together with further water-soluble foods and/or food additives as well as suspensions of water and insoluble or partially soluble foods. Also included are all types of solutions and suspensions comprising monohydric and polyhydric alcohols (for example aromas comprising propylene glycol as a vehicle; glycerine) and comprising sugar alcohols (such as sorbitol, xylitol, mannitol, isomalt, malbitol, lactitol, erythritol etc.). The percentages by mass of hydrophilic food additive given here do not take into account the amounts of water (generally <0.5 or <1%) normally contained in chocolates or filling masses.

Advantageously, it is provided that the intermediate layer made of the chocolate mass has a content of 0.01 to 5% by mass of a finely dispersely distributed hydrophilic food additive, in other words a hydrophilic food additive which comprises at least one monohydric or polyhydric alcohol or at least one sugar alcohol, in other words at least one alcohol according to the invention, and which is introduced during processing. As will be discussed in detail in the following, this addition of a defined content of hydrophilic food additive results in an immediate increase in the viscosity and the flow limit. This treatment immediately converts the chocolate mass into a semi-solid, plastically deformable state. As a result of the high viscosity and the high flow limit, it is possible to apply relatively thick layers as an intermediate layer. This would not be possible in the chocolate masses known in the art, since they have low viscosities and flow limits and would flow just under the inherent weights thereof if applied in a thick layer. The use of the hydrophilic food additive according to the invention further has the advantage over the use of water that it is more simply possible to work it in homogeneously as a result of the better distributability and dispersibility in chocolate masses, it being possible to achieve an increase in the flow limit just with small amounts of hydrophilic food additive. In addition, the use of at least one monohydric or polyhydric alcohol or at least one sugar alcohol also has the further microbiological advantage over the use of pure water that potential multiplication of microorganisms is prevented.

It will be understood that in the context of the invention the term “viscosity” relates to the ductility and flowability of the chocolate mass. This is an apparent viscosity, since the chocolate mass is a non-Newtonian medium.

As a result of the solution according to the invention, it is particularly advantageously possible during the manufacture of baked confectionery products to achieve thickness of between 2.5 mm and 15 mm of the intermediate layer. In particular, according to the invention the texture of the chocolate mass is solid when the baked confectionery product is finished, in such a way that a considerable bite resistance or “crunch” is achieved upon consumption as well as melting, as is familiar to the consumer when consuming chocolate bars.

The solution according to the invention thus includes shaping a filling layer in the form of a highly viscous, paste-like chocolate or comparable fat-containing filling mass, precisely positioning the filling mass, simultaneously or at a separate time, between two, generally plate-like baked good pieces. In general, the filling mass is still deformed somewhat, and as good a contact as possible is achieved between the touching surfaces of the chocolate (filling layer), which has not yet fully crystallised, and the baked good. Subsequently, as the product is cooled further the chocolate layer crystallises and the three layers are firmly connected.

The precise temperature progression in the cooling process and the observance of the relative air humidity in the cooler are of relevance for the quality of the end product.

The invention discloses a method for preparing the chocolate in such a way that at the time of the connection to the baked good it is sufficiently viscous (paste-like) that the shape of the filling mass, formed after flowing through a cross-section for example of a nozzle, is changed as lithe as possible. This means that the flow limit of a filling mass of this type is above the minimum flow limit. The minimum flow limit corresponds to the critical shear stress. It is the stress which the filling mass can receive without transitioning into a state of the layers sliding and thus of flowing. If the critical shear stress is exceeded as a result of anisotropic forces which act externally on the body or forces acting on the individual layers of the body due to the inherent weight thereof, this results in sliding or flowing and thus in plastic deformation.

The invention provides that a chocolate or comparable fat-containing filling is pre-treated before portioning in such a way that preferably 0.01 to 5% by mass hydrophilic food additive is introduced into a pre-crystallised chocolate or pre-temperature-controlled filling mass and finely dispersely distributed, and as a result the chocolate filling mass is converted into a semi-solid paste-like state prior to portioning between two biscuits. The finely dispersely distributed drops of hydrophilic food additive can be produced by mixing or intensively stirring in the open stirring vessel. However, this involves the risk that air may also be incorporated and finely dispersely distributed. This is generally undesirable. To prevent the incorporation of air bubbles, the mixing space has to be filled completely with the mixture of chocolate and water. Alternatively, mixing in a vacuum is possible. The mixing time and shearing intensity are dependent on the specific selection of the hydrophilic food additive (for example aqueous solution comprising at least one monohydric or polyhydric alcohol or at least one sugar alcohol, water-soluble aromas comprising propylene glycol (propane diol) as a vehicle), the selection of the mixing systems and the flow limit and viscosity which are to be defined as target variables.

The mass thus obtained has a significantly higher viscosity and flow limit, without the proportion of crystalline phase in the fat melt increasing. The rise in viscosity and flow limit results from the fact that
1. the fat proportion in chocolate and fat-containing filling mass is generally precisely high enough for it to be possible to ensure the required flow properties (flow limit and viscosity),
2. part of the free, liquid fat in the pre-temperature-controlled chocolate/filling mass is immobilised, as a result of enclosing the finely dispersely distributed drops, with the introduction of a hydrophilic food additive.

The necessary metered amount of hydrophilic food additive for setting a desired flow limit and viscosity is basically dependent on the size of the finely dispersely distributed drops. Smaller drop diameters mean an increase in the surface area of the hydrophilic food additive in the chocolate or filling mass and thus stronger immobilisation of liquid fat. The results are a large increase in the flow limit and viscosity. There is an influence on the drop size from the composition of the hydrophilic food additive and the nature and intensity of the dispersal method. Care should be taken that during the dispersal the seed crystals found in the chocolate/filling mass are not melted again as a result of excessive energy input during shearing.

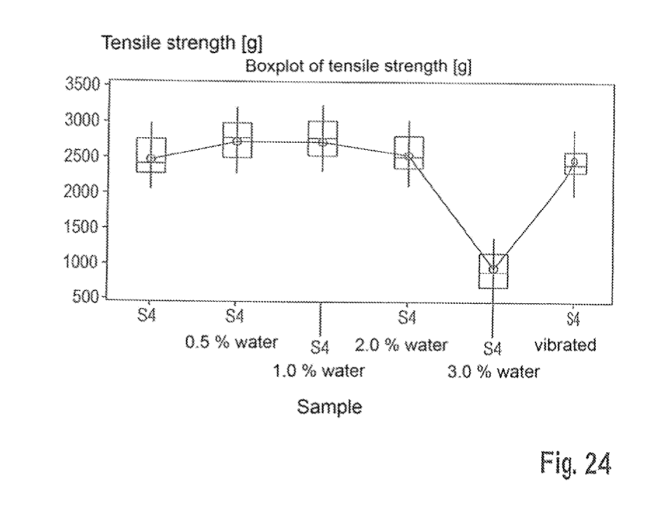

In the following, the invention is described further by way of feature groups. The feature groups describe the methods according to the invention in any desired combination:
Baked confectionery product and method for manufacturing a sandwich-like baked confectionery product comprising two substantially plate-like baked good parts and a clearly visible intermediate layer located between them in the form of a solid filling.
The dimensionally stable and solid filling is made of chocolate and/or a comparable fat-containing mass.
The solid, crystallised filling has a density of at least 1 g/cm³. preferably 1.2 to 1.3 g/cm³.
The filling is clearly visible between the two baked good parts.
The distance between the two baked good parts and thus the height of the intermediate layer is at least 2.5 mm.
The distance between the two baked good parts and thus the height of the intermediate layer is at most 15 mm.
The distance between the two baked good parts results in a thickness of the intermediate layer of the chocolate mass according to the invention which is preferably 3 to 7 mm thick, preferably 3 to 4 mm thick, preferably 4 to 15 min,
The lateral edges of the filling mass are substantially parallel and offset slightly inwards from the edges of the baked good parts.
The lateral contour is formed in such a way that the edges of the filling mass end substantially at the side edges of the baked good parts.
The lateral contour is formed in such a way that the edges of the filling protrude substantially parallel to the side edges of the baked good parts.
The side faces of the filling have a semi-matt appearance typical of chocolate.
The plate-like baked good parts have substantially the same outer contour, but the configuration of the faces in the interior of the contour of the upper and lower face may differ.
The plate-like baked good parts have substantially the same outer contour, but the configuration of the faces in the interior of the contour may differ between the upper and the lower baked good part.
The filling is connected to the baked good parts without additional joining mass.
The baked good parts and the filling are firmly interconnected and can no longer be separated without being damaged.
The weight ratio of baked good parts to fill may be in the range between 3 to 1 and 1 to 4.
The weight ratio of baked good parts to filling is preferably in the range between 2 to 1 and 1 to 2.
Upon consumption in the temperature range from 20° C. to 25° C., the filling mass produces a sensory impression typical of a chocolate bar of comparable thickness.
In the context of a comminution upstream from the processing as an intermediate layer, by rolling mills or ball mills or comparable comminution methods, the particle size distribution of the filling masses is in the range typical of chocolate.
The filling made of chocolate or chocolate-like filling masses contains a hydrophilic food additive, preferably in a proportion of 0.01 to 5% by mass, in particular at least 0.01% by mass and at most 2.5% by mass, preferably from 0.05 to 1% by mass, particularly preferably less than 0.5% by mass and in particular 0.1% by mass to 0.3% by mass.
Preferably, the hydrophilic food additive is or contains propylene glycol or the hydrophilic food additive is or contains a mixture of water and propylene glycol.
The proportion of hydrophilic food additive is selected as a function of the fat proportion of the chocolate or the fat-containing, substantially water-free filling mass and the specific hydrophilic food additive, in such a way that the increase in the viscosity and flow limit necessary for processing is achieved, but the sensory properties (solidity) after drying and during storage do not differ significantly from systems not treated with hydrophilic food additives (FIG. 24). This is for example ensured at added amounts of 2.5% by mass hydrophilic food additive or <0.5 by mass polyhydric alcohol (propylene glycol).
For raising the flow limit by way of a hydrophilic food additive, all types of aqueous solution or suspension comprising at least one monohydric or polyhydric alcohol or at least one sugar alcohol and comparable substance systems may be used, as long as they are immiscible or poorly miscible with the fads contained in chocolate or fat-containing filling masses.
High-fat, low-viscosity chocolates and filling masses having fat proportion (>32% by mass to 50% by mass), as well as high-viscosity, low-fat chocolates or filling masses having fat proportions in the range of 25 to 32% by mass, may be used as a basis for the filling.
Alternatively, the intermediate layer is constructed from a plurality of filling masses, which differ in visual and/or sensory and/or receptor terms.
The intermediate layer is constructed from two to five filling masses positioned on top of one another or side by side or filling masses extending inside one another in part.
Fragmented parts, having a minimum particle size of 1 mm and a maximum particle size of 0.7×distance between the baked good parts in millimetres, are worked into the intermediate layer.
An intermediate layer or one or more filling volumes having a water-containing filling are worked in between or into the filling.
The water-containing filling is a marmalade, jam or other fruit preparation, and either sufficient drying takes place after the metering or the water-containing filling is positioned in one or more filling volumes inside the subsequently solid filling.
The filling intermediate layer is a caramel filling, and either sufficient drying takes place after the metering or the caramel filling is positioned in one or more filling volumes inside the subsequently solid filling.
The intermediate filling layer consists of a preparation of marzipan, persipan or comparable nut-containing confectionery masses, which are preferably completely enclosed by the fat-containing filling mass(es)/chocolate(s).
Method for manufacturing a sandwich-like baked confectionery product (as described above) comprising two substantially plate-like baked good parts and a clearly visible intermediate layer located between them in the form of a solid filling, comprising the following working steps:
   a. manufacturing or providing the baked good parts;
   b. providing the fat-containing filling mass(es)/chocolate(s);
   c. pre-treating the liquid, fat-containing filling mass(es)/chocolate(s) in a first step, in such a way that after this method step is completed there are seed crystals located therein (pre-temperature-controlled filling mass(es)/chocolate(s));
   d. pre-treating the pre-temperature-controlled filling mass, which is still liquid after working step (c.), in such a way that a hydrophilic food additive is finely dispersely and homogeneously distributed into these filling mass(es)/chocolate(s) by stirring, in such a way that a water-in-oil emulsion having a significantly higher flow limit, above the critical shear stress, and a significantly higher viscosity is manufactured;
   e. shaping and portioning the pre-temperature-controlled filling mass(es)/chocolate(s), which substantially do not flow under the inherent weight of the filling mass and baked good parts, onto a baked good part located below which is adjusted to the filling system.
   f. applying a second, adjusted baked good part;
   g. pressing the upper baked good part onto the intermediate layer and onto the lower baked good part and simultaneously finishing the shape of the intermediate layer;
   h. finally cooling the sandwich-like baked confectionery product.
The hydrophilic food additive is introduced into the pre-temperature controlled filling mass by rapidly mixing in (homogenising) using a stirring tool, and finely dispersely distributed, and it is thus ensured that a sufficient proportion of seed crystals is still obtained.
The hydrophilic food additive is introduced into the pre-temperature-controlled filling mass by rapidly mixing in using a stirring tool, preferably in a stirring space without the presence of air or other gases which might otherwise become finely dispersely distributed in the filling mass, or in a vacuum.
The amount of hydrophilic food additive in the filling mass is in particular in the range of 0.01 to 5% by mass, preferably in the range of 0.01% by mass to 2.5% by mass, in particular in the range of 0.05 to 1% by mass, in particular less than 0.5% by mass and particularly preferably in the range of 0.1% by mass to 0.3% by mass, depending on the fat content and the flow properties of the water-free, pre-temperature-controlled chocolate/filling mass, the necessary increase in the flow limit, the composition of the hydrophilic food additive and the dispersal method.
The shape of the filling is determined by extruding through a nozzle and opening and closing the nozzle using a seal, the cross-section of the nozzle, the height and width of the filling layer and the duration of the metering process determining the length of the filling layer.
The filling layer is extruded and applied by vertically extruding the filling layer onto the baked good lower part and cutting the filling layer using a (preferably heated or vibrating) wire or a (preferably heated or vibrating) blade.
The first baked good part is brought into position with respect to the filling system, before the filling mass is portioned, in such a way that precise application of the filling mass is ensured.
During the application of the filling mass, the relative speeds between the filling tool and the support system for the baked part and between the filling mass and the lower baked good part are approximately zero.
The filling tool moves during the application of the filling mass at a speed differing from the speed of the lower baked good part.
The second baked good part is received by a pneumatic aspirator or a gripper tool and placed and pressed accurately and precisely on the provided unit consisting of the baked good part positioned below and filling mass located on top, the filling being brought into the final shape thereof as a result of the pressing.
The filling mass is shaped vertically, and the baked good parts are connected to the filling layer substantially simultaneously by supplying the baked good parts laterally, pressing them on in parallel, and cutting the filling portion from the extruded strand downstream.
The filling mass is shaped vertically, and the portioned filling mass is taken up at the subsequent side edges of a conveying system. In a subsequent step, the baked good parts are connected to the filling layer by substantially simultaneously supplying the baked good parts laterally and pressing them on in parallel.
The filling mass is shaped by pressing the filling mass into a mould, which is defined by the contour of a piston which moves in a guide, and subsequently demoulding this filling mass onto the first baked good part, by moving the cylinder and separating the filling layer from the cylinder stamp using a heated wire and by removing the preferably temperature-controlled cylinder stamp from the composite of cake and filling positioned below.
The method, is carried out by means of a rotating system in the form of a rotating drum comprising stamps or by means of one or more rotating rings comprising stamps.
The method is carried out means of a rotating system in the form of a rotating drum provided with recesses or a corresponding rotating ring, above which a funnel comprising filling mass is arranged and which passes the filling mass pressed into the cavities in the drum onto the baked good lower parts which pass through synchronously under the drum, the material of the contact face between the filling mass and the drum or ring and the temperature of the drum or the ring being selected in such a way that the adhesive forces are overcome by the inherent weight of the filling body.
By way of the nozzle, a plurality of filling masses are pressed, shaped and positioned simultaneously via a plurality of supply ducts.
A plurality of filling masses are positioned on the lower baked good part, on top of one another or side by side, in temporal succession.
At least two or more filling masses are pressed through a nozzle so as to extend inside one another.
In a subsequent step, the sandwich-like connection consisting of two baked parts and a filling consisting of one or more filling masses is cooled with the aim of guiding the crystallisation of the fat in such a way that the products are storage-stable and are dried sufficiently for the subsequent packing process.
The cooling conditions are selected in such a way that both the optimum crystallisation of the filling (chocolate) and the obtainment of the desired textural features of the baked good parts are ensured.

In the following, the invention is disclosed by way of embodiments in relation to the drawings, in which:

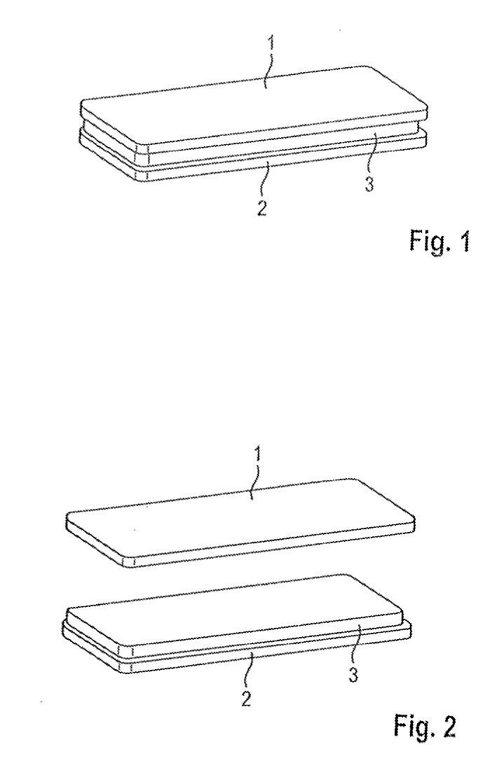

FIG. 1 is a simplified perspective drawing of the baked confectionery product according to the invention,

FIG. 2 is a partial exploded view of the drawing of FIG. 1,

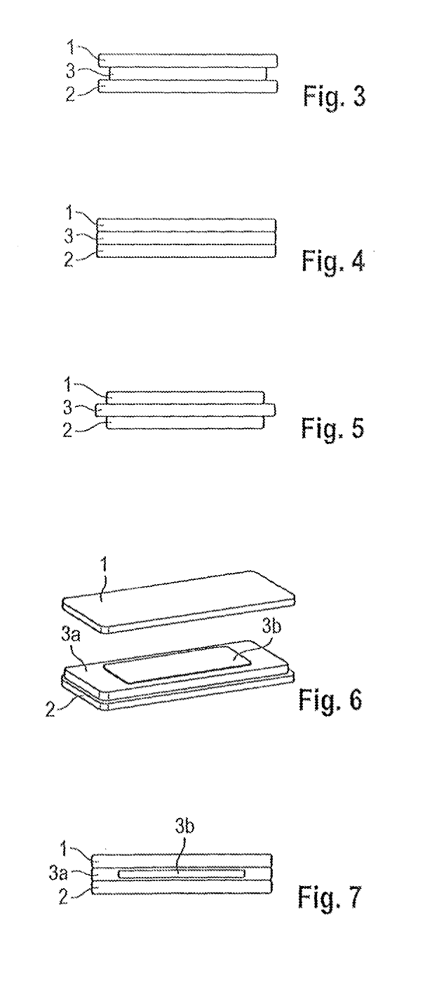

FIGS. 3 to 5 are side views of different variant configurations of the width of the intermediate layer,

FIGS. 6 to 10 are different variant configurations of the intermediate layer according to the invention,

FIG. 11 shows viscosity-shear curves of a non-temperature-controlled chocolate mass having various proportions of water,

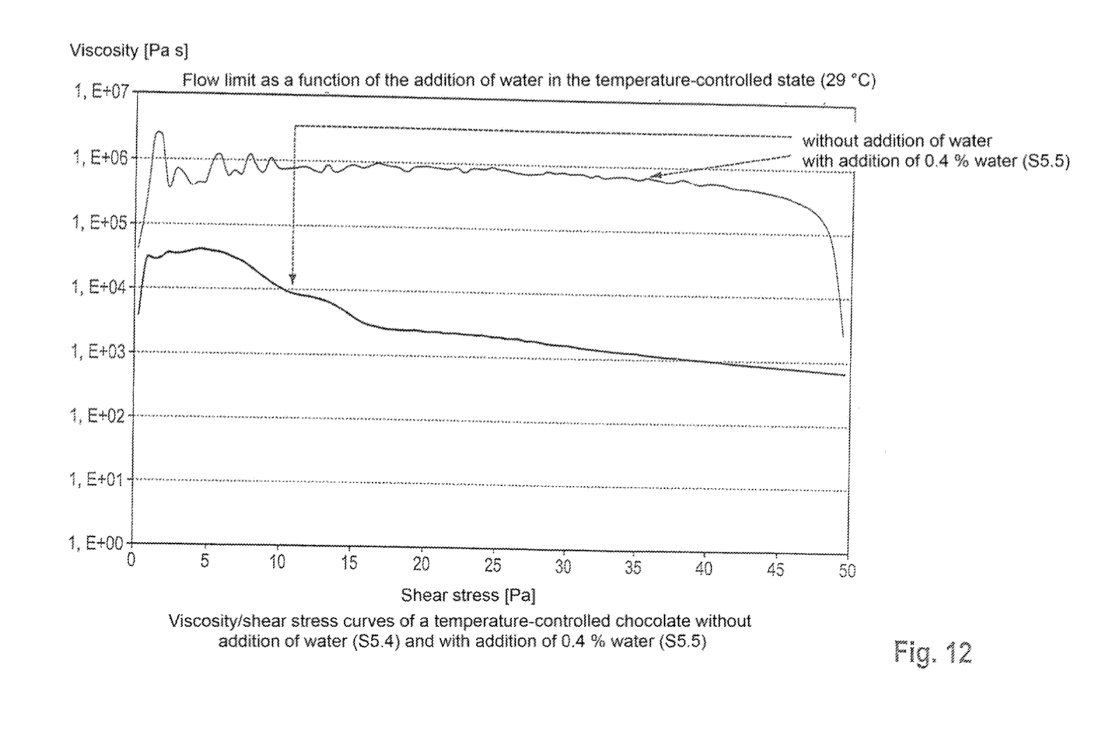

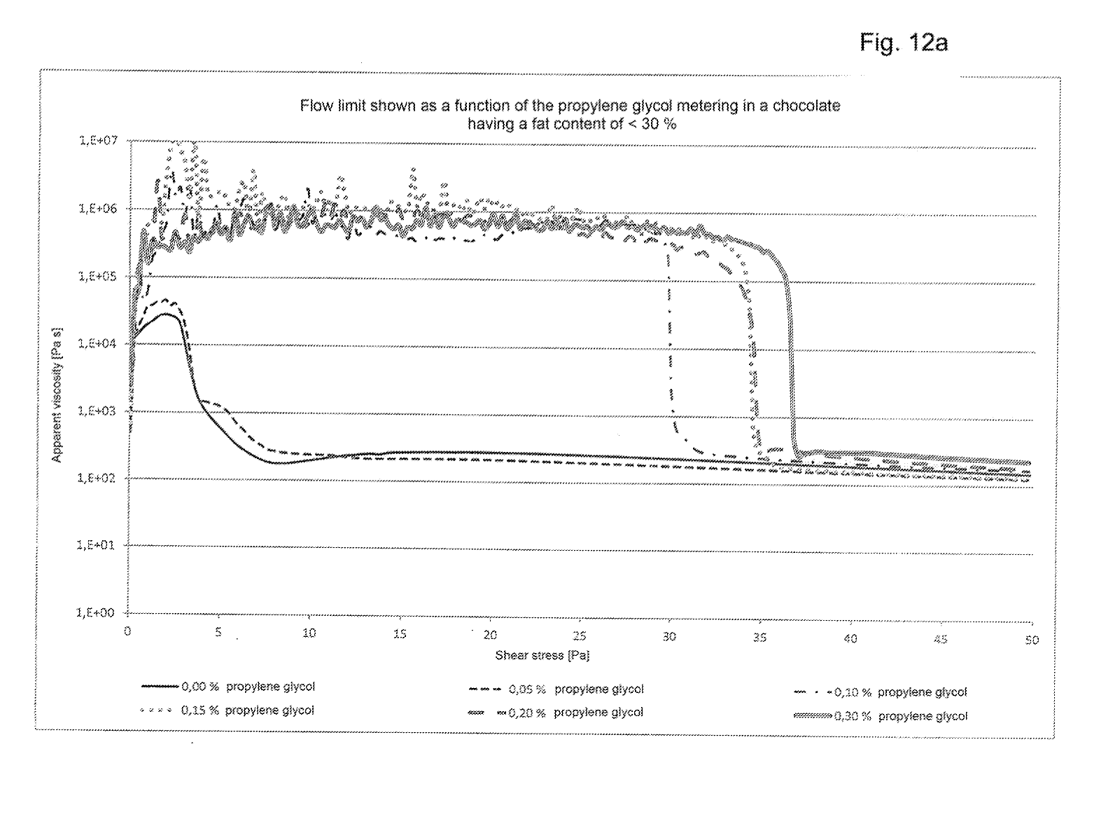

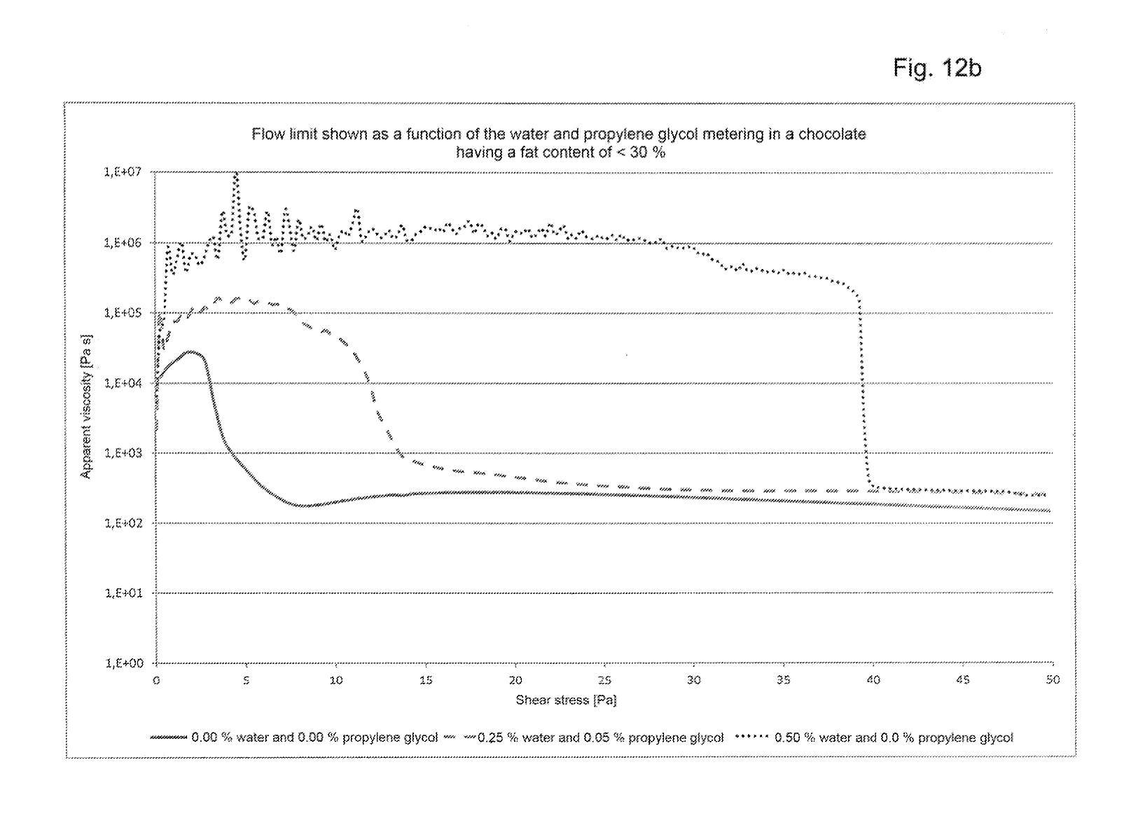

FIG. 12 is a drawing analogous to FIG. 11 of various viscosity-shear curves of a temperature-controlled chocolate without the addition of water and with the addition of 0.4% by mass water,

FIG. 12a is a drawing analogous to FIG. 12 of various viscosity-shear curves of a temperature-controlled chocolate having different proportions of propylene glycol,

FIG. 12b is a drawing analogous to FIG. 12 of various viscosity-shear curves of a temperature-controlled chocolate having various proportions of a mixture of water and propylene glycol,

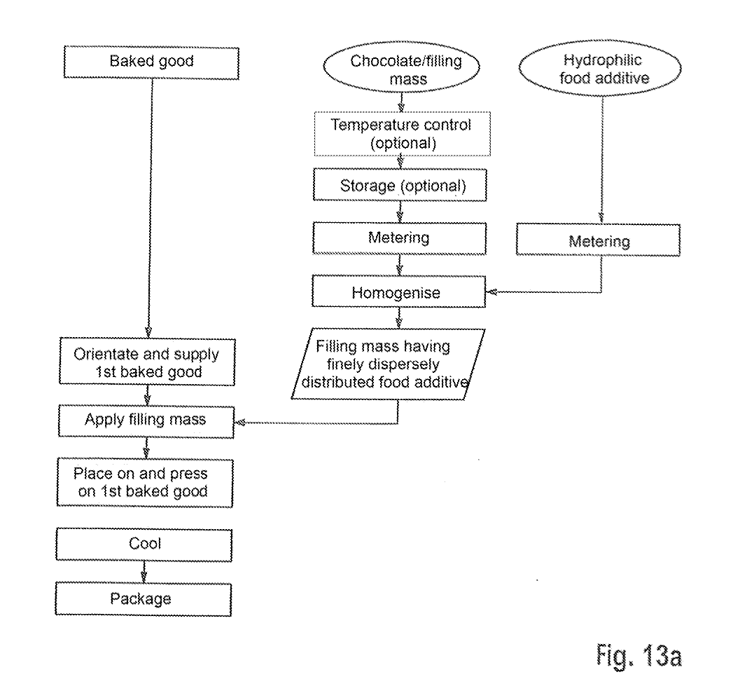

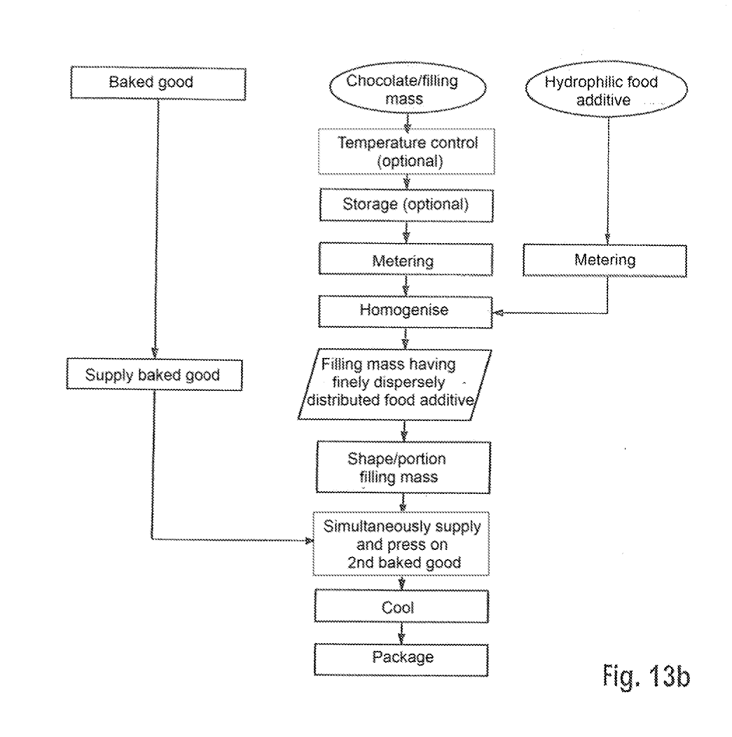

FIGS. 13a and 13b are flow charts of variant configurations of the method of manufacture according to the invention,

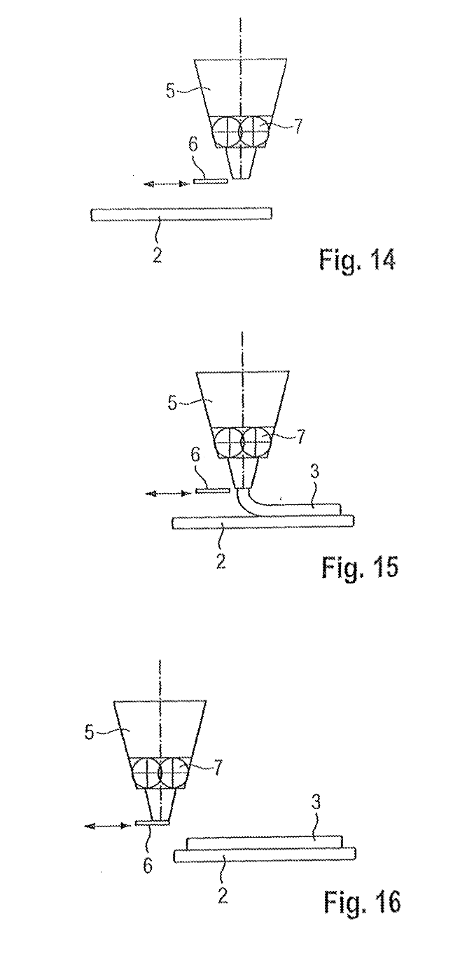

FIGS. 14 to 16 are schematic side views of a device for applying the intermediate layer by means of a nozzle,

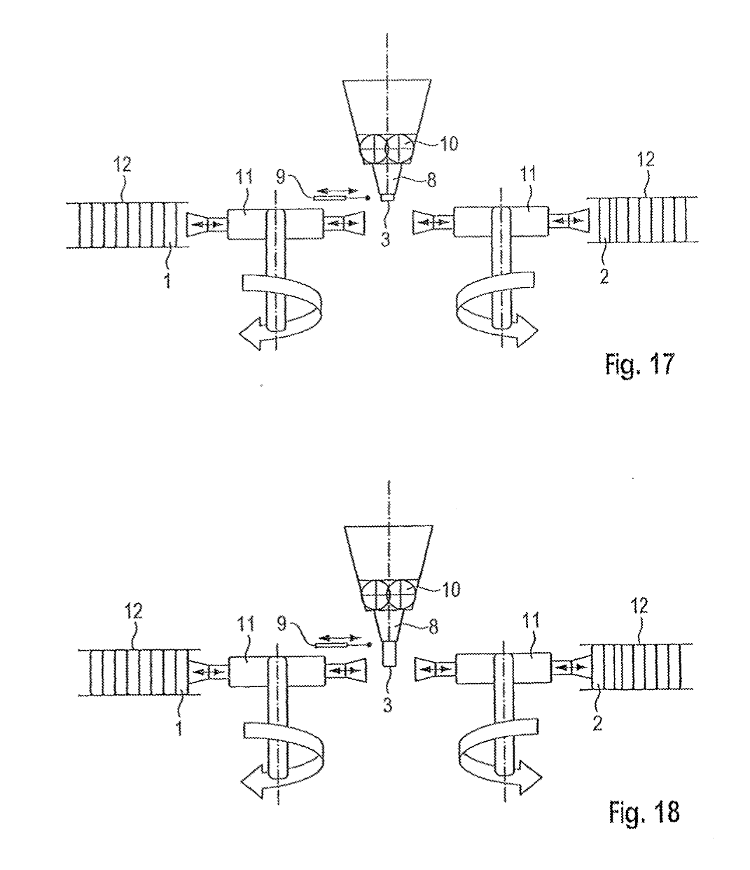

FIGS. 17 to 21 are schematic views of a further device according to the invention for applying the intermediate layer in successive working steps,

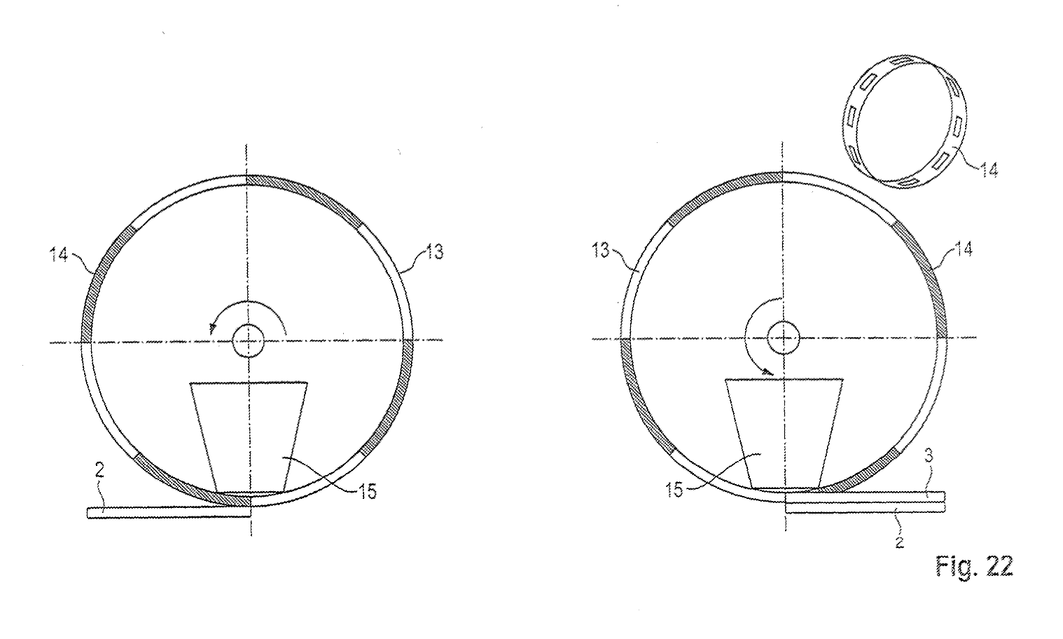

FIG. 22 is a schematic drawing of a further device according to the invention,

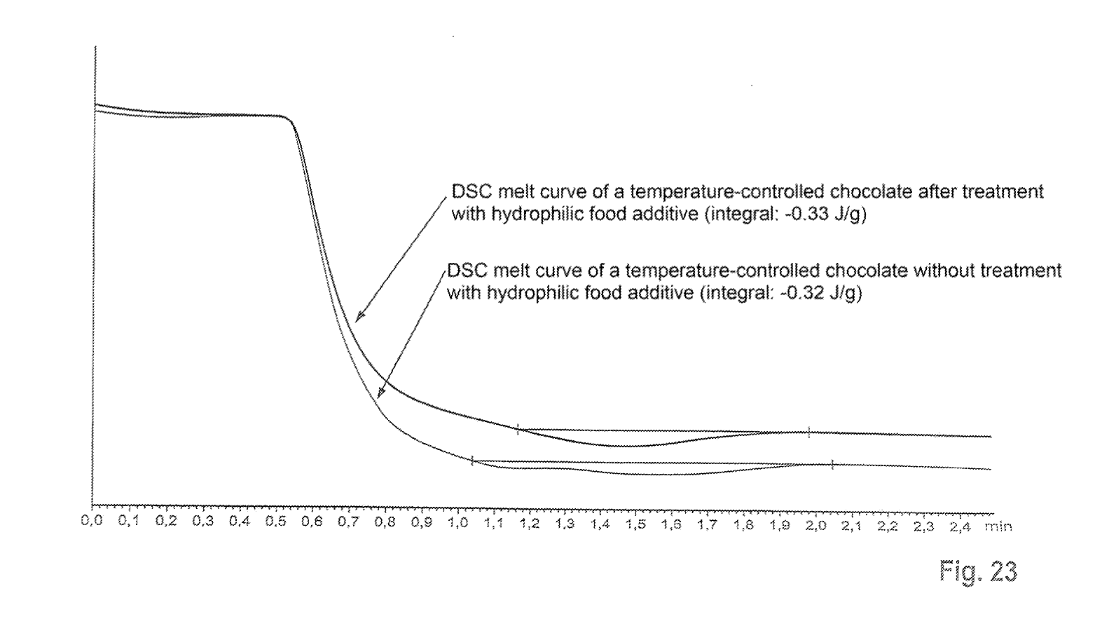

FIG. 23 is a graphical drawing comparing a temperature-controlled chocolate melt before and after treatment with water,

FIG. 24 is a graphical drawing of the influence of the water content on the texture of chocolate, and

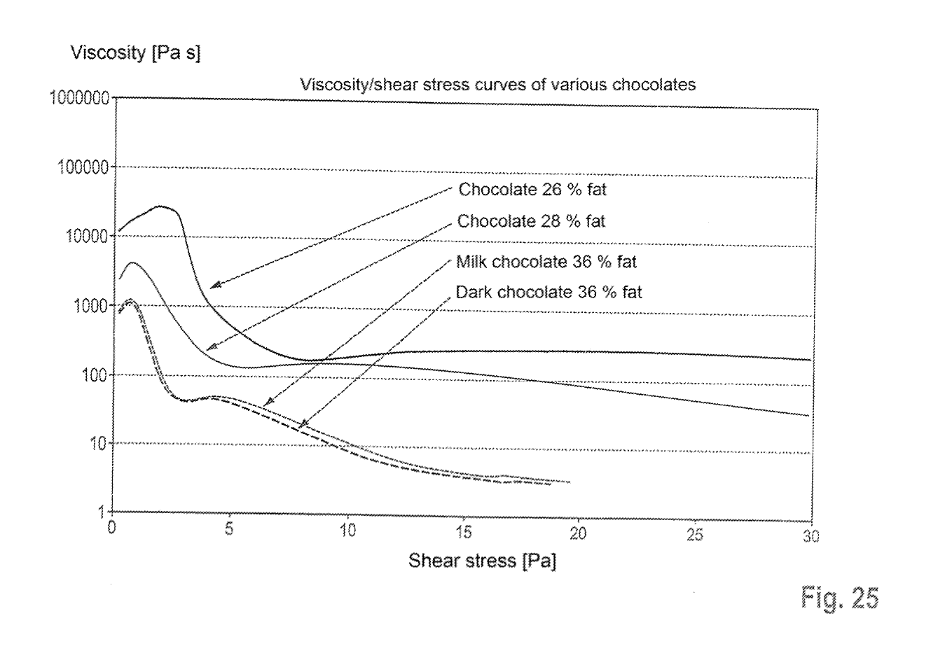

FIG. 25 shows viscosity-shear curves of various chocolates.

FIGS. 1 and 2 are simplified schematic drawings of an embodiment of a baked confectionery product according to the invention in the form of a sandwich baked good.

The sandwich baked food comprises an upper baked good part 1 and a lower baked good part 2, which is in the form of plate-like biscuits. FIG. 1 is a highly schematic drawing in which the baked good parts 1, 2 are cuboid in shape. It will be understood that the side faces of the baked good parts 1 and 2 may be ribbed, wavy or otherwise structure. The same applies to the respective upper and lower faces of the baked good parts 1 and 2 (visible faces and contact faces with the intermediate layer 3).

A plate-like filling, which forms an intermediate layer 3 and thus constitutes a filling mass, is arranged between the two baked good parts 1 and 2.

FIGS. 3 to 5 are simplified side views of possible variant configurations, which vary as regards the width of the intermediate layer 3. In FIG. 3, the intermediate layer is formed with a narrower width, in such a way that the lateral edges of the baked good parts 1 and 2 protrude laterally. In the embodiment shown in FIG. 4, a flush configuration of the intermediate layer 3 is provided, whilst FIG. 5 shows an embodiment in which the intermediate layer (filling mass) 3 protrudes laterally past the edges of the baked good pieces 1 and 2.

FIGS. 6 to 10 show variant configurations of the intermediate layer 3. This may, as is shown in FIG. 6, comprise a frame-like intermediate layer 3a, in the centre of which a further intermediate layer 3b is arranged. This may differ from the intermediate layer 3a. FIG. 7 shows a variant in which the intermediate layer 3b is enclosed both laterally and from above and below by the mass of the intermediate layer 3a. It is thus possible, in accordance with the embodiment of FIGS. 6 and 7, to enclose for example a softer or more liquid intermediate layer mass 3b in a harder intermediate layer mass 3a according to the invention.

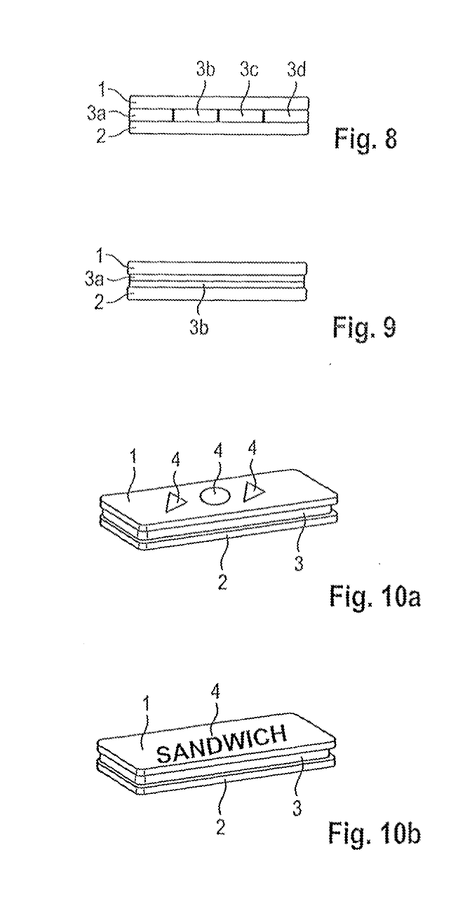

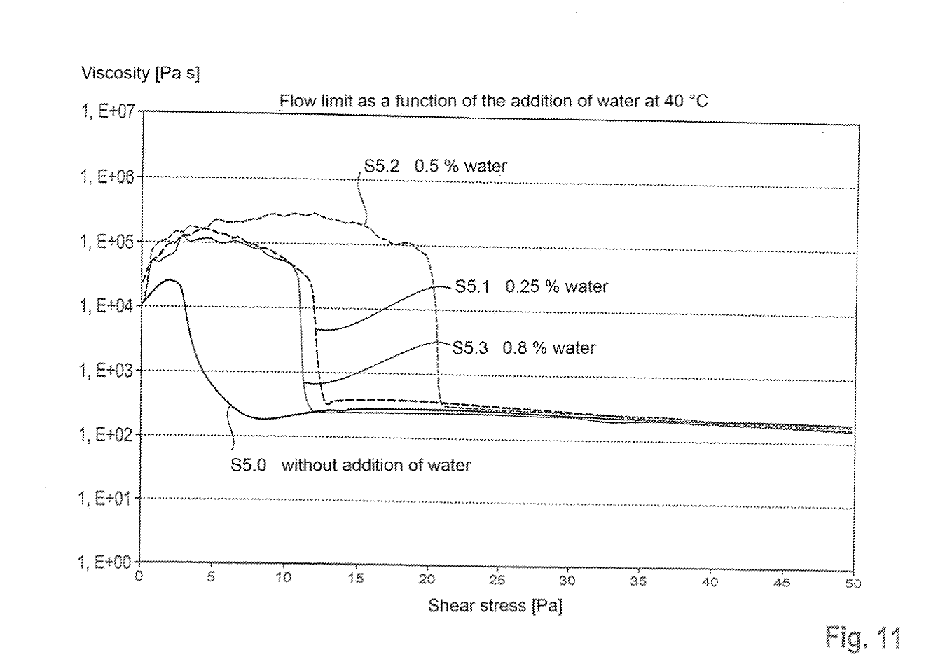

FIGS. 8 and 9 show variant configurations comprising a plurality of intermediate layers. According to FIG. 8, these intermediate layers 3a to 3d are laid side by side in strips, whilst in accordance with the embodiment of FIG. 9, the two intermediate layers 3a and 3b are arranged on top of one another. FIGS. 10a and 10b show variants in which the upper baked good part 1 is provided with recesses 4, through which the intermediate layer 3 is visible and/or through which parts of the intermediate layer 3 can be pressed into the recesses.

FIG. 11 shows by way of example the flow limit of the chocolates when different proportions of water are added, by comparison with the untreated sample S5 (without the addition of water), when non-temperature-controlled at 40° C. It can be seen very clearly that the addition of water in a proportion of 0.5% leads to the greatest shift in the flow limit. When 0.8% water was added, a similar effect on the influence on viscosity and flow limit is achieved to when 0.25% was added.

FIG. 12 shows by way of example the effect of the addition of water in the non-temperature-controlled state. When 0.4% is added, there is a considerable rise in the flow limit. This addition has now produced a mass which has a flow limit in the region of 50 Pa at 29° C. A mass of this type can be portioned and shaped well.

FIG. 12a shows by way of example the change in the flow limit of chocolates having a fat content of less than 30% when different proportions of propylene glycol are added as a hydrophilic food additive, by comparison with an untreated sample (without the addition of propylene glycol), in the temperature-controlled state at approximately 29° C. It can clearly be seen that even a very slight addition of propylene glycol, in this of 0.05% by mass shown by way of example, brings about an increase in the viscosity and in the flow limit of the chocolate. This effect is even clearer for proportions of propylene glycol in the chocolate of 0.1% by mass to 0.3% by mass. In this case too, the propylene glycol was worked into the chocolate mass particularly homogeneously. The propylene glycol was distributed finely dispersely, in particular by comparison with water, resulting in a paste-like, spreadable and uniform mass having a high viscosity and a high flow limit.

FIG. 12b shows by way of example the change in the flow limit of chocolates having a fat content of less than 30% when different proportions of a mixture of water and propylene glycol are added as a hydrophilic food additive, by comparison with an untreated sample (without the addition of water and without the addition of propylene glycol), in the temperature-controlled state at approximately 29° C. In this case too, it can clearly be seen that even a very slight addition of hydrophilic food additive, for example in proportions of 0.30% by mass (0.25% by mass water and 0.05% by mass propylene glycol) or 0.60% by mass (0.50% by mass water and 0.10% by mass propylene glycol), brings about an increase in the viscosity and the flow limit of the chocolate. It was easily possible to work in the mixture of water and propylene glycol. A homogeneous, paste-like, spreadable mass having a high viscosity and a high flow limit was obtained.

Overall, it can thus be established that the metrological analyses are congruent with the experiences according to the invention when temperature-controlled chocolate is processed. For example, it was found that the addition of 0.2 to 0.6% by mass water (based on the proportion of water in the hydrophilic food additive) had the best effect for chocolates having approximately 27 to 30% fat content. For aromas having propylene glycol as a vehicle, an advantageous metering amount of 0.1% is found (based on the propylene glycol content in the hydrophilic food additive).

The optimum amount of hydrophilic food additive is additionally influenced by the fat content of the chocolate and the type and degree of advance temperature control. For low-fat chocolates having a temperature-control level of 5 to 6 (measured using a SOLLICH temperature control lever meter), a metering amount of 0.4 to 0.5% by mass based on the proportion of water or 0.06 to 0.15% by mass based on the proportion of propylene glycol in the hydrophilic food additive was found to be optimal at a desired layer thickness of 5 mm.

For example, for a sandwich product having a layer thickness of 5 mm of filling having a density of 1.260 g/cm³ and a biscuit have a height of 5 mm and a density of 0.850 g/cm³, this results in a critical shear stress of approximately 42 Pa for the filling. For each millimetre increase in the filling layer, the critical shear stress increases by approximately 5.5 to 6 Pa.

Conventional shear stress levels are in the range of <2 Pa for non-temperature-controlled high-fat chocolates and <5 Pa for low-fat chocolates. At this point, it should be noted that all of the rheological analyses carried out herein were carried out using a Malvern KINEXUS viscometer, using a plate-plate system having a diameter of 50 mm and plate spacing of 1 mm. The shear stresses increased from 0 to 50 Pa on a linear slope in 100 s.

In the temperature-controlled state, the flow limit increases. For example, the viscosity and the flow limit are measured for a low-fat chocolate having 28% fat. In this case the flow limit rises to the region of approximately 7 Pa before flowing sets in (see FIG. 11).

The rise in the flow limit to the upper detected theoretical range of 40 to 50 Pa and possibly higher has not been a conventional method step in the processing of chocolates thus far. Rather, the prior art technology for processing chocolates aims to set a low viscosity and flow limit during the laying or manufacture of shaped chocolate on single-plate systems.

FIG. 13a is a flow chart of the method of manufacture according to the invention. The upper baked good part 1 and the lower baked good part 2 are prepared and baked in the conventional manner. In parallel with this, the filling mass of the intermediate layer 3 is manufactured. This is subsequently temperature-controlled, for example to a temperature of between 24° C. and 33° C. According to the invention “temperature control” means producing a melt. For this purpose, the chocolate mass is generally initially cooled to temperatures of <26° C., and subsequently heated back up to the region of approximately 28° C. to 32° C. Seed crystals (beta V crystals) are seeded in the process. However, according to the invention, these seed crystals, which are used for the subsequent crystallisation, may also be added in the form of powder or as grated chocolate A cocoa butter/seed crystal suspension (cocoa butter melt) could also be added. After the temperature control, the filling mass of the intermediate layer 3 is stored, then metered, then homogenised and in the process mixed with the predetermined proportion of hydrophilic food additive. This homogenised mass is applied to the first, baked good part as a filling mass. Subsequently, the second baked good part is placed and pressed on The finished sandwich baked good is subsequently cooled and packed.

Thus In the method according to the invention, to manufacture a sandwich-like product comprising a chocolate filling, the flow properties of the chocolate are selectively set, by suitable advance temperature control and by producing or introducing seed crystals (beta V seed crystals for chocolate), in such a way that the flow limit of the pre-treated mass is above the critical shear stress at the time of portioning or filling. It is thus possible to place a dimensionally stable, paste-like filling layer of chocolate or a suitable fat-containing filling between two baked good pieces (biscuits).

The sandwich according to the invention can be manufactured in various ways. In a specific configuration, the filling mass is metered onto a pre-existing baked good piece. The cross-section of a nozzle corresponds to the cross-section made up of the filling height and filling width or filling length. By way of a longitudinal movement of the baked good piece with respect to the filling nozzle, a simultaneously shaped filling strand is laid on. To ensure a uniform filling flow rate, the filling is preferably conveyed through the nozzle using a pump. The metering process is ended by stopping up the pump. To ensure a precise termination, mass is additionally pulled back from the nozzle by way of a suck-back stroke, and the filling mass exiting the nozzle is simultaneously separated from the nozzle head by a slide. In terms of the surfaces, the materials of the filling nozzle and of the slide are to be selected in such a way that fat-containing masses adhere as little as possible. In addition, it is advantageous to heat the filling nozzle and the slide. For chocolate, surface temperatures of 30° C. to 34° C. are advantageous.

In a second step, the second baked good piece is laid on the unit consisting of the baked good piece positioned below and the filling mass, as mentioned previously. By pressing the upper baked good piece onto the lower baked good piece in a defined manner, the shape of the filling layer is finished and a good contact layer between the filling and the respective inner faces of the upper and lower baked good parts is ensured. This is relevant for ensuring a good, stable connection between the filling layer and the two baked goods.

After this working step, the connected sandwich piece is finally cooled. Sufficient cooling times should be selected as a function of the specific piece construction (weight, dimensions). For baked goods having a layer thickness of 6 to 10 mm, minimum cooling times of 15 minutes are recommended at a cooling temperature of 14° to 16° C. Cooling times of 30 minutes are optimal. Care should be taken that an air humidity suitable for baked goods is set in the cooler, in such a way that there is no undesirable increase in the backed good humidity during the cooling process.

Another variant on the manufacture of the sandwich consisting of filling mass and two baked good pieces involves extruding the filling mass from a nozzle and simultaneously laterally supplying and pressing on the baked good pieces. The chocolate can be separated subsequently, for example by way of a heated or vibrating wire or a blade (see FIG. 13b).

FIGS. 14 to 16 are simplified drawings of a device for applying the filling mass according to the invention, It comprises a pump 7, downstream from which there is a nozzle 5. As is shown in FIG. 14, the filling mass is extruded through the nozzle 5 by means of the pump 7. A slide 6 is opened in the process. Simultaneously, a lower baked good part 2 is transported in. FIG. 15 shows the process of applying the filling mass 3 to the lower baked good part 2. As a result of the high viscosity of the filling mass, it is applied to the lower baked good part 2 in the form of a viscous layer. After complete application of the intermediate layer 3, the slide 6 closes the nozzle 5, in such a way that a following lower baked good part 2 can be brought into the region of the nozzle 5.

FIG. 17 shows a filling system for shaping and simultaneously positioning biscuits in accordance with a further embodiment of the invention. Reference numeral 8 indicates a nozzle, to which a pump 10 is assigned. Above the pump, there is a reservoir for the mass. The outlet of the nozzle 8 can be opened and closed by means of a slide 9, as is shown by way of the double-headed arrow. Reference numeral 11 indicates a transport device. This is a rotating system which can be rotated about a shaft, as is indicated by the two arrows. Further, the transport device 11 is laterally displaceable, as is likewise indicated by the double-headed arrows. The transport device 11 comprises an aspirator or gripper or the like for taking individual baked products from a baked product stack 12 (biscuit stack) and transporting them towards the nozzle 8 by way of the rotation about the shaft of the transport device 11.

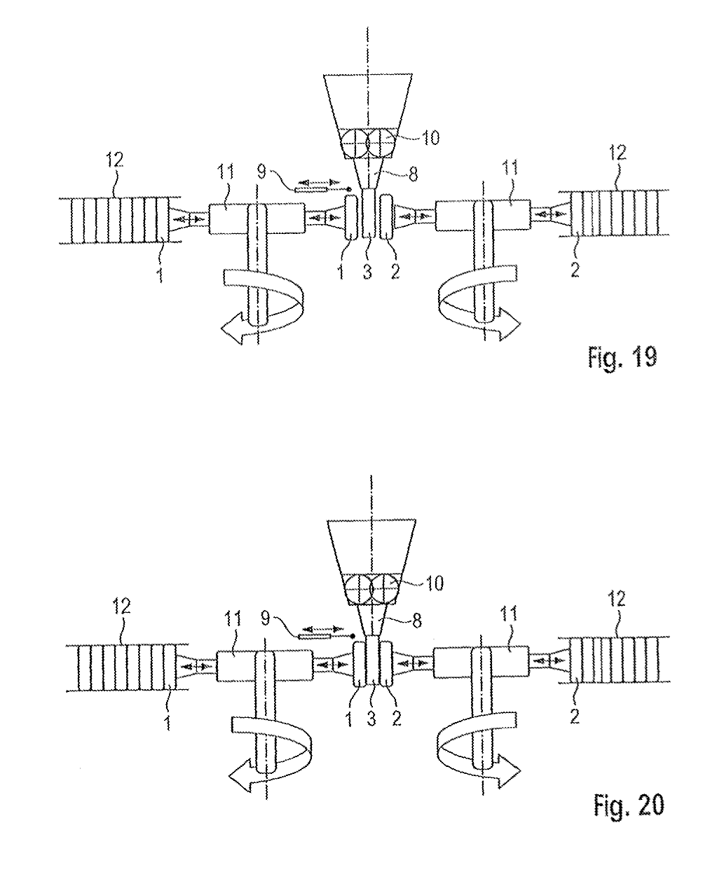

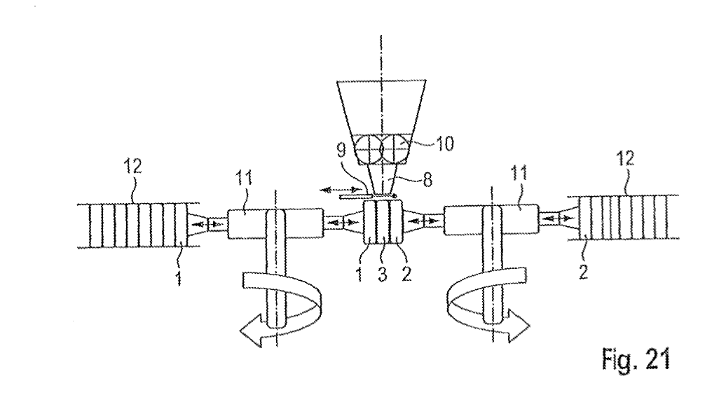

FIG. 18 shows the first working step, in which the transport device 11 has been moved towards the respective baked product stack 12 and is gripping a baked product (biscuit) by way of the associated aspirator. The slide 9 still has the outlet of the nozzle 8 open, in such a way that an amount of filling mass exits the nozzle 8. FIG. 19 shows the next working step, specifically the shaping of the filling mass/chocolate and the allocation of the baked products. By comparison with FIG. 18, it can be seen that the transport device 11 has rotated in such a way that two baked products are each arranged alongside an outputted strand of the filling mass 3. The slide 9 is still open. FIG. 20 shows the next working step, in which the baked products are pressed against the filling mass 3. FIG. 21 shows the following working step, specifically separating the filling portion and conveying the sandwich away. For this purpose, the slide 9 closes the outlet of the nozzle 8, in such a way that the sandwich-like baked product consisting of the baked products 1 and 2 and the filling mass 3 can be transported away and processed further.

FIG. 22 shows a further variant of a device according to the invention. This comprises a ring or a drum 14 comprising recesses 13 arranged on the periphery. The drum 14 acts as a slide, and rotates about the central axis shown. Reference numeral 15 indicates a funnel or a nozzle. The funnel may have a slight overpressure, and the filling mass is located therein. The left half of FIG. 22 shows the start of the filling task. In this context, a baked product 2 is slid under the funnel 15 or under the drum 14. By allocating the appropriate recess 13, the filling mass 3 is extruded during a longitudinal movement of the baked product 2 along the drum 14. This is shown in the right half of FIG. 22. The top right of FIG. 22 is a perspective, simplified drawing of the drum or the ring application system.

FIG. 23 is a graphical representation of a DSC analysis of temperature-controlled chocolate with (S1.1) and without (S1.0) the addition of water. Hardly any changes in the melt are found. This is evidence that the chocolate according to the invention comprises crystallised fat before and after treatment. There is no major difference in the heat required to melt the crystallised fat. There are thus very similar, almost equal heat values. This shows that the proportion of crystallised fat in the two chocolates is substantially equal.

FIG. 24 is a box plot which shows the influence of the content of hydrophilic food additive, in the form of water, on the texture of chocolate. FIG. 24 show that the addition of water up to 2.5% has no significant influence on the texture of the crystallised chocolate.

FIG. 25 shows viscosity-shear curves of different chocolates measured with a KINEXUS viscometer (measurement conditions: plate-plate system, Φ50 mm, spacing 1 mm, 40° C., shear stress increasing linearly from 0 to 50 Pa in 100 s). The top curve was measured in a chocolate having a fat content of 26%, and the second curve from the top was measured at a fat content of 28%. The lowest two curves both relate to a fat content of approximately 36%).

### LIST OF REFERENCE NUMERALS

1 Upper baked good part/baked product

2 Lower baked good part/baked product

3 Filling mass/intermediate layer

4 Recess

5 Nozzle

6 Slide

7 Pump

8 Nozzle

9 Slide

10 Pump

11 Transport device

12 Baked product stack

13 Recess

14 Drum

15 Funnel/nozzle

1. Baked confectionery good comprising an upper planar plate-like baked product, comprising a lower planar plate-like baked product and comprising at least one planar intermediate layer, which is made of a chocolate mass, characterised in that the intermediate layer comprises a hydrophilic food additive which contains at least one monohydric or polyhydric alcohol or at least one sugar alcohol.

2. Baked confectionery good according to claim 1, wherein the hydrophilic food additive content is 0.01% by mass to 5% by mass, in particular at least 0.01% by mass and at most 2.5% by mass, preferably 0.05% by mass to 1% by mass and particularly preferably less than 0.5% by mass.

3. Baked confectionery good according to claim 1, wherein the hydrophilic food additive content is 0.1% by mass to 0.3% by mass.

4. Baked confectionery good according to claim 1, wherein the hydrophilic food additive is or contains propylene glycol or in that the hydrophilic food additive is or contains a mixture of water and propylene glycol.

5. Baked confectionery good according to claim 1, wherein the thickness of the intermediate layer is 2.5 mm to 15 mm.

6. Method for manufacturing a sandwich-like baked confectionery good comprising an upper planar, plate-like baked product, comprising a lower planar, plate-like baked product, and comprising at least one planar intermediate layer, in particular according to claim 1, comprising the following working steps:
providing the lower baked product,
applying a semi-solid, paste-like, dimensionally stable, substantially non-aerated intermediate layer, having a flow limit above the critical shear stress determined from the inherent weight of the product, the intermediate layer being made of a chocolate mass and the intermediate layer comprising a hydrophilic food additive which contains at least one monohydric or polyhydric alcohol or at least one sugar alcohol, applying the upper baked product.

7. Method according to claim 6, wherein the intermediate layer is prepared by temperature-controlling the chocolate mass and introducing the hydrophilic food additive.

8. Method according to claim 6, wherein the hydrophilic food additive is or contains propylene glycol or in that the hydrophilic food additive is or contains a mixture of water and propylene glycol.

9. Method according to claim 6, wherein the hydrophilic food additive is introduced in such a way that it is finely dispersely distributed.

10. Method according to claim 9, wherein the finely disperse distribution of the hydrophilic food additive is additionally carried out in a vacuum and/or without the presence of gases.

11. Method according to claim 6, wherein the intermediate layer is applied to the lower baked product by way of a shaping nozzle.

12. Method according to claim 11, wherein the intermediate layer is supplied vertically and applied to the lower baked product by way of the nozzle.

13. Method according to claim 11, wherein a strand of the material is applied to the intermediate product precisely in terms of shape by way of the nozzle.

14. Method according to claim 6, wherein a plurality of intermediate layers are applied in a horizontal opposed position or side by side or structured inside one another.

15. Method according to claim 6, wherein the filling is positioned and shaped in the cavities of a rotating drum.

16. Method according to claim 15, wherein the filling mass is released from the cavity onto the supplied baked good piece under the inherent weight thereof.

17. Method according to claim 16, wherein the drum is heated.

18. Method according to claim 15, wherein the filling mass is applied from the cavity to the supplied baked good piece by way of a stamp.

19. Method according to claim 17, wherein the filling mass is separated from the stamp by way of a (heated) wire, blade or scraper.

20. Method according to claim 6, wherein the upper baked product is pressed on after the application of the intermediate layer.

21. Method according to claim 6, wherein the baked products are connected to the pre-shaped filling mass simultaneously by pressing on laterally or vertically.

22. Method according to claim 21, wherein the portioning takes place by way of separation of the filling strand before the filling is connected to the baked good pieces.

23. Method according to claim 21, wherein the portioning takes place by way of separation of the filling strand after the filling is connected to the baked good pieces.
